(19) United States
(12) Patent Application Publication
(10) Pub. No.: US 2023/0372972 A1
(43) Pub. Date: Nov. 23, 2023

(54) A PHASE SHIFTING MECHANISM

(71) Applicant: Aydin OZKAN, Sincan, Ankara (TR)

(72) Inventor: Aydin OZKAN, Sincan, Ankara (TR)

(21) Appl. No.: 18/247,991

(22) PCT Filed: Mar. 11, 2021
(86) PCT No.: PCT/TR2021/050214

§ 371 Date: Apr. 5, 2023

(30) Foreign Application Priority Data
Oct. 8, 2020 (TR) 2020/16003

(51) Int. Cl. B06B 1/16

(52) U.S. Cl. CPC B06B 1/166

(57) ABSTRACT

Disclosed is a phase shifting mechanism which is adapted to shift the phase between the motion transmission members and particularly a phase shifting mechanism suitable for use in vibro hammers.

### FIELD OF THE INVENTION

The present invention relates to a phase shifting mechanism which is adapted to shift the phase between the motion transmission members and particularly a phase shifting mechanism suitable for use in vibro hammers.

### BACKGROUND OF THE INVENTION

Vibro hammers are mounted on parts such as steel formed pipes and profiles, and have wide application in driving and extracting these parts to and from the soil. Vibro hammers drive pipes or profiles to soil by means of their eccentric weights.

The European patent application document no. EP2834422 (A1), known in the state of the art, discloses a vibro hammer; which is mounted on parts such as steel formed pipes and profiles and used in driving and extracting these parts to and from the soil, and is able to rotate without resonance; and which, by means of the transmission device whose main parts are the stepped shaft, toothed piston and transmission body, performs phase change between the upper weight set and lower weight set with fewer parts. A transmission device is provided in the said vibro hammer, and phase change between the upper weight set and lower weight set is performed by means of the said transmission device. The transmission device is actuated by filling with the hydraulic fluid from two different channels, and this may cause hydraulic fluid leakage over time and deformation of the transmission device in a short period time.

The United States patent document no. U.S. Pat. No. 5,253,542, known in the state of the art, discloses a system which is comprised of two weights turning in opposite directions and wherein the lower weight part is coupled to the upper weight part by a transmission device. The said transmission device is comprised of two coaxial shafts each comprising helical teeth and a piston which slides between the two shafts, delimiting therewith at least one working chamber into which a pressurized hydraulic fluid is injected. In this system, the transmission device is comprised of two devices namely the first and second transmission device. In this system, where there is a plurality of devices, it is difficult to attain the same axis and the fact that the system is comprised of two devices causes it to get deformed more rapidly.

The United States patent document no. US20020104393, known in the state of the art, discloses that the variable moment vibratory driver hydraulically shifts the phase of two sets of eccentric weights via a transmission device. It is one of the objectives of the invention to provide a variable moment vibratory driver which decreases vibrations. There are internal and external helical teeth on the transmission device but since the shaft within the transmission device is fixed by a ball bearing from a single side, the forces acting on the shaft cause the shaft to rapidly fail and to get deformed easily. Therefore this system has a more unsound structure.

### OBJECTIVES OF THE INVENTION

An object of the present invention is to provide a phase shifting mechanism which enables to realize the phase shifts between two different motion transmission means.

Another object of the present invention is to provide a phase shifting mechanism which can mechanically work without need for a hydraulic fluid therein.

A further object of the present invention is to provide a phase shifting mechanism which performs phase shifting by enabling one motion transmission member to rotate slightly more relative to another motion transmission member.

### DETAILED DESCRIPTION OF THE INVENTION

The phase shifting mechanism developed to achieve the object of the present invention is illustrated in the accompanying figures wherein,

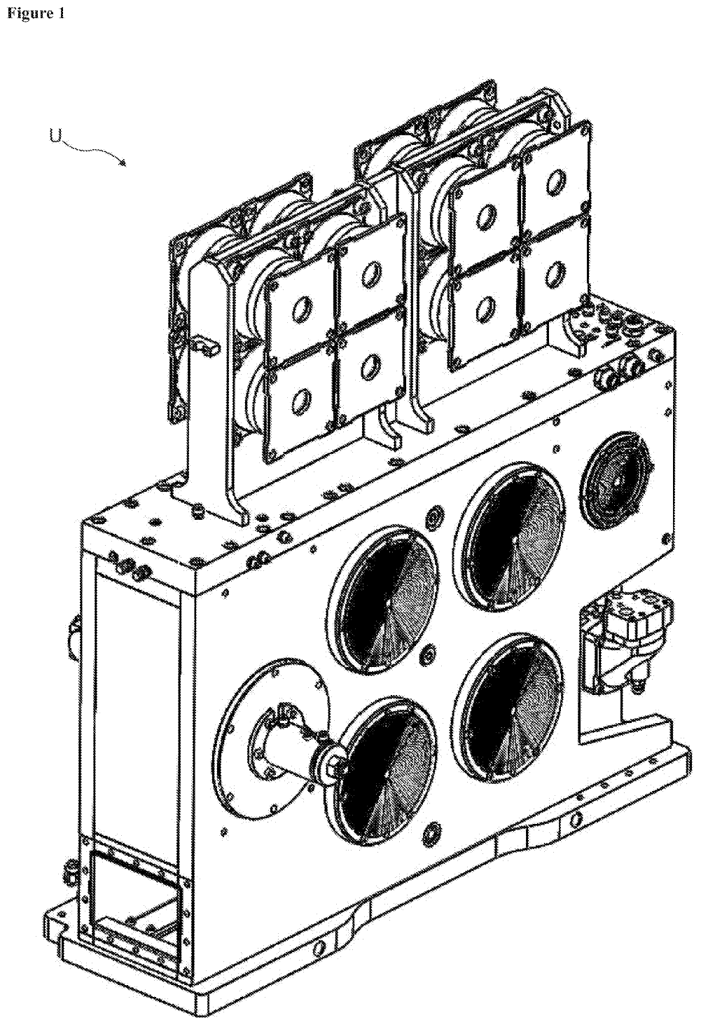

FIG. 1. is a perspective view of the vibro hammer.

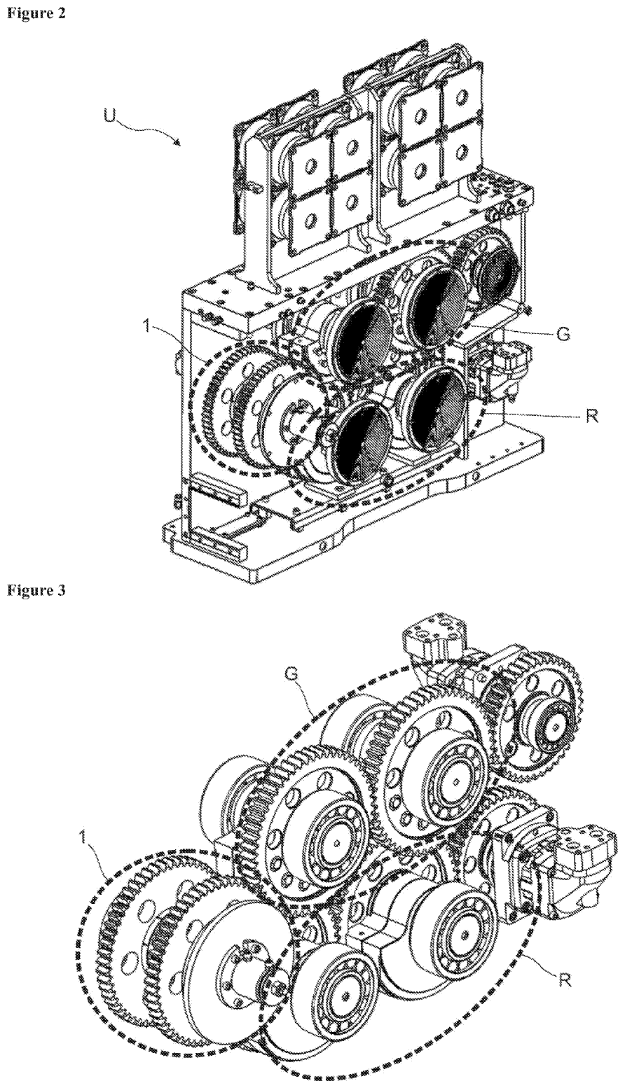

FIG. 2. is a perspective view of the phase shifting mechanism together with the first and second weight sets provided within the body of the vibro hammer.

FIG. 3. is a perspective view of the phase shifting mechanism together with the first and second weight sets without the body of the vibro hammer.

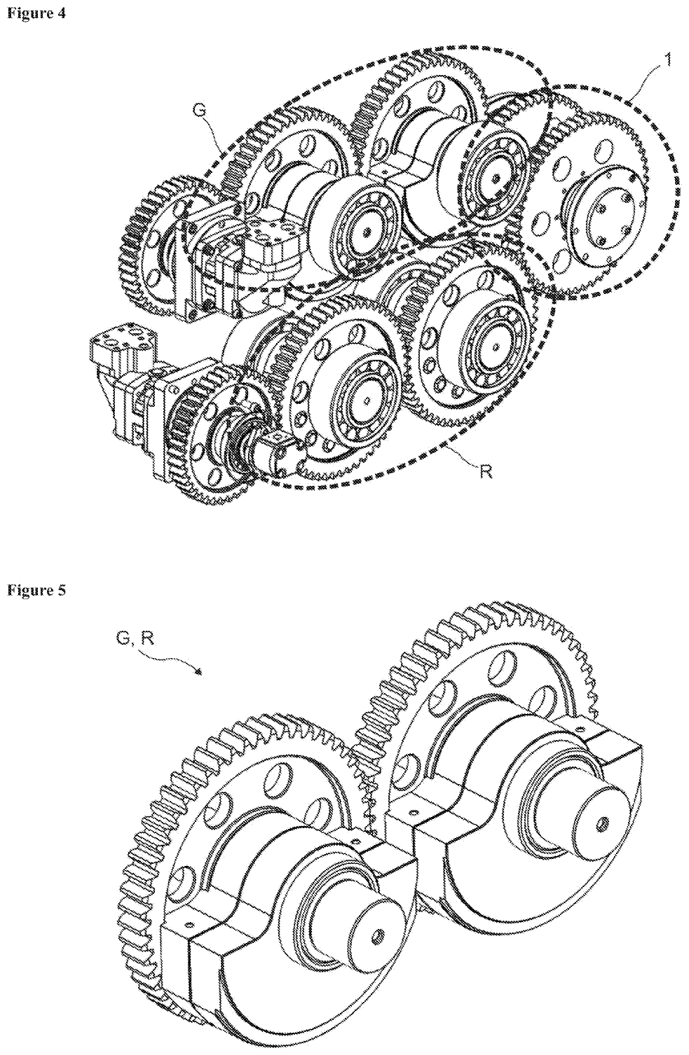

FIG. 4. is a perspective view of the phase shifting mechanism together with the first and second weight sets without the body of the vibro hammer from another angle.

FIG. 5. is a perspective view of the first and second weight sets.

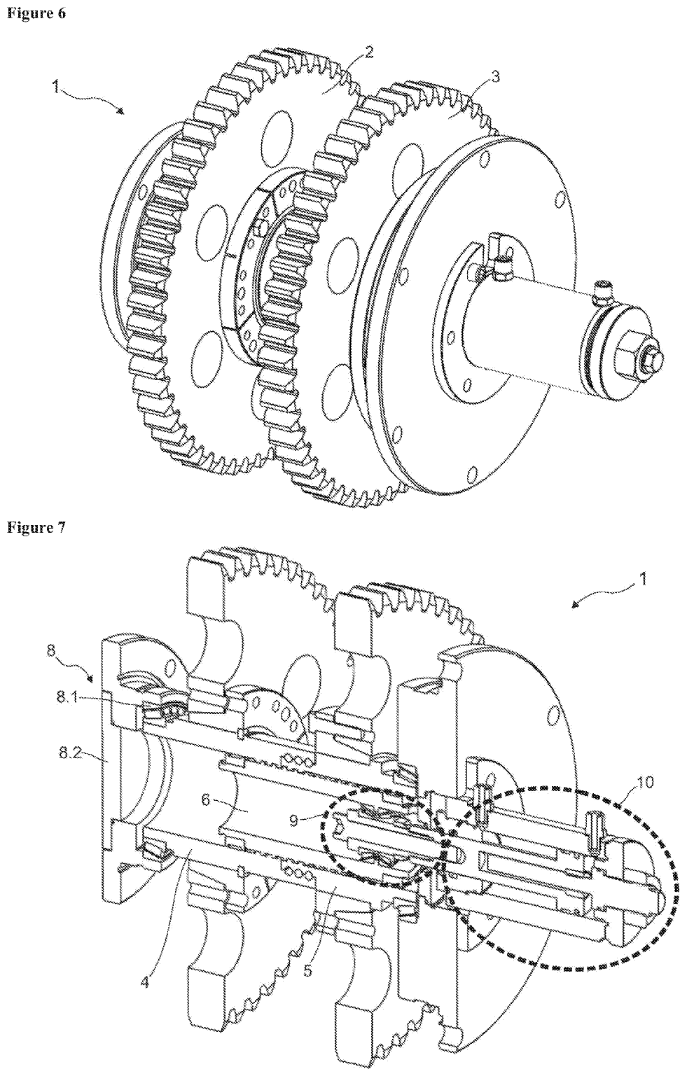

FIG. 6. is a perspective view of the phase shifting mechanism.

FIG. 7. is a sectional perspective view of the phase shifting mechanism.

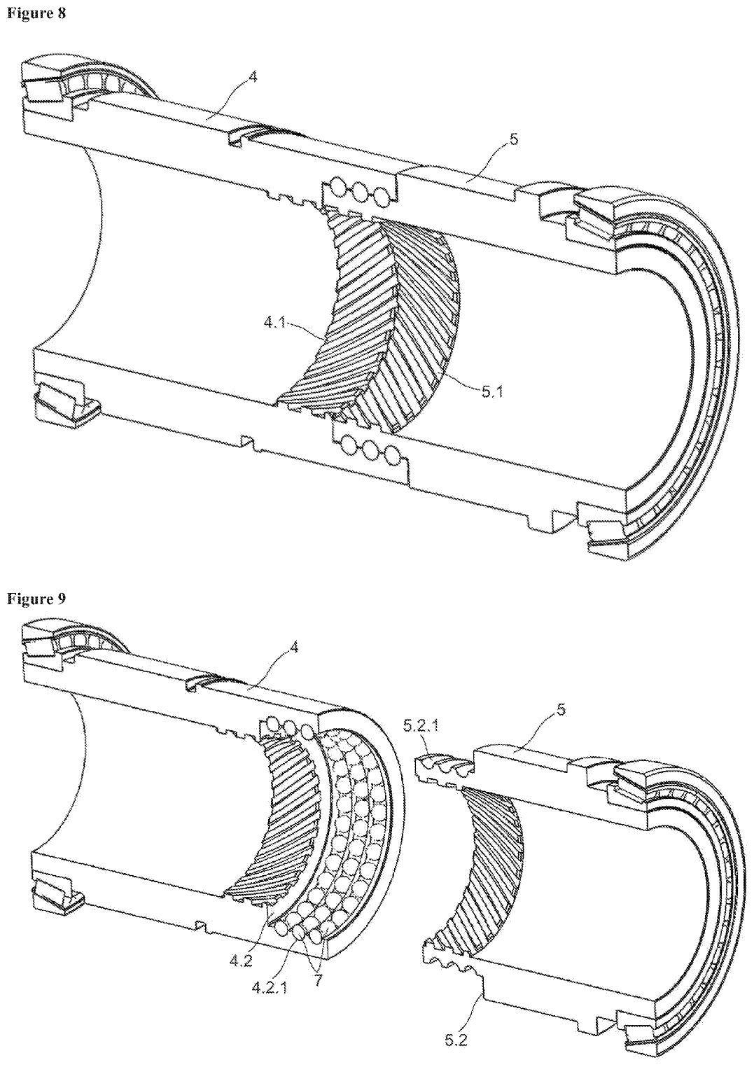

FIG. 8. is a sectional perspective view of the first and rotary members coupled to each other.

FIG. 9. is a sectional perspective exploded view of the first and rotary members.

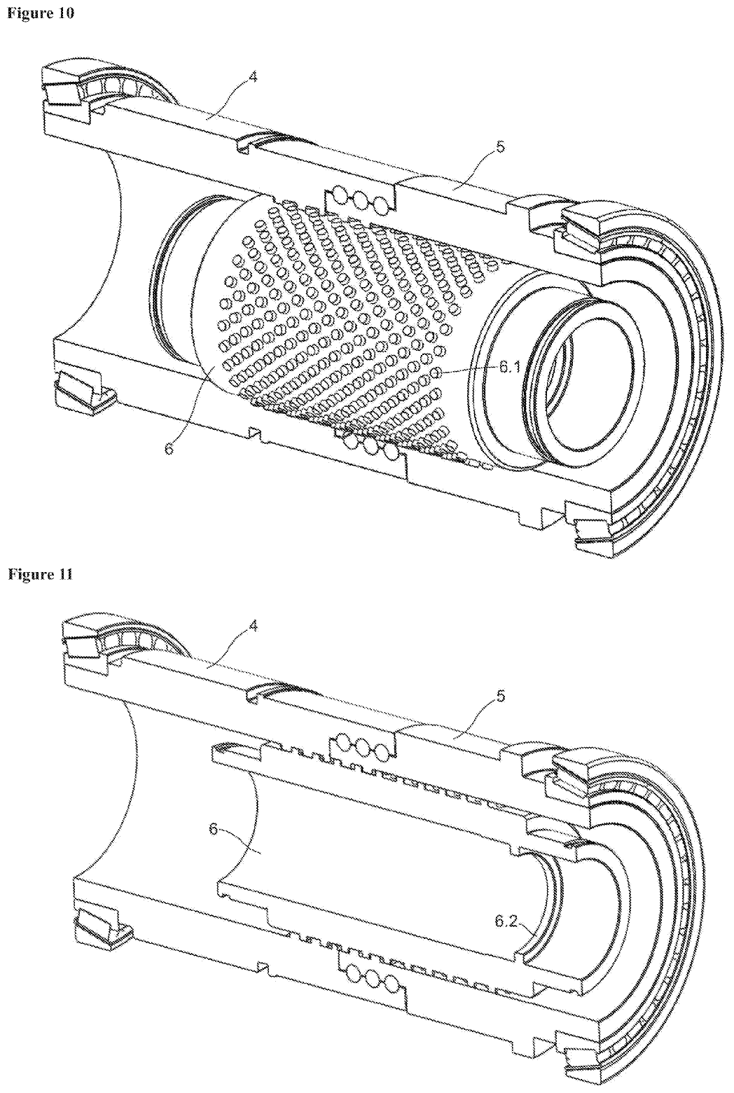

FIG. 10. is a perspective view of the sectional first and rotary members and the whole phase shifter.

FIG. 11. is a sectional perspective view of the first and rotary members and the phase shifter coupled to each other.

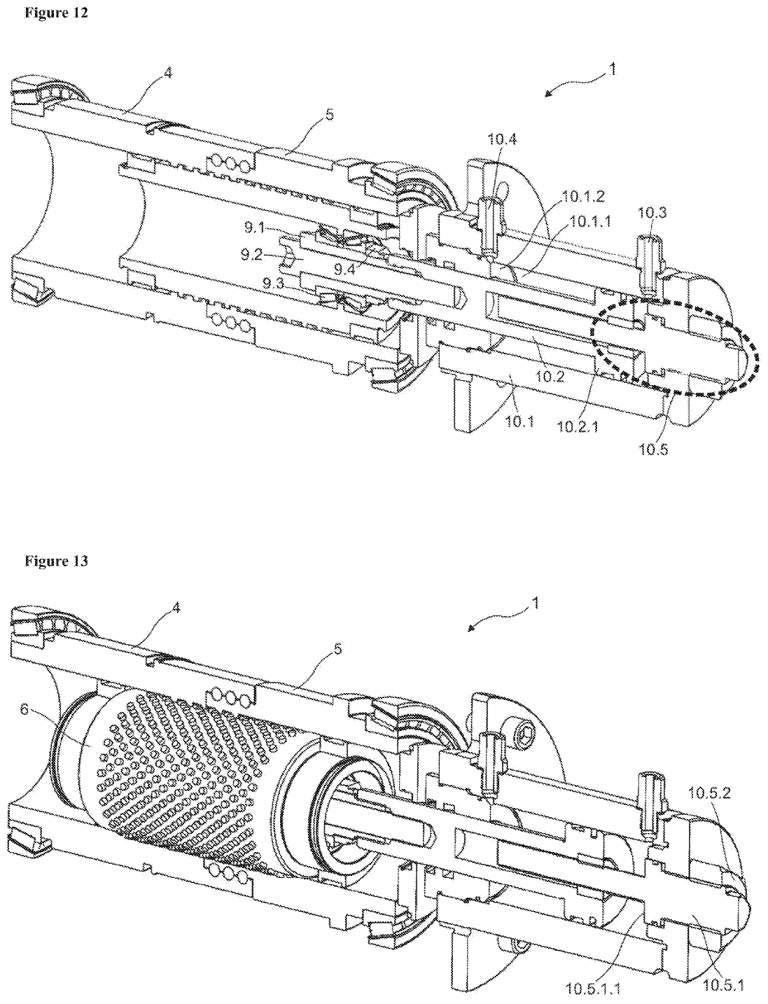

FIG. 12. is a sectional perspective view of the phase shifting mechanism without the first and second transmission members.

FIG. 13. is a perspective view of the sectional phase shifting mechanism without the first and second transmission members and the whole phase shifter.

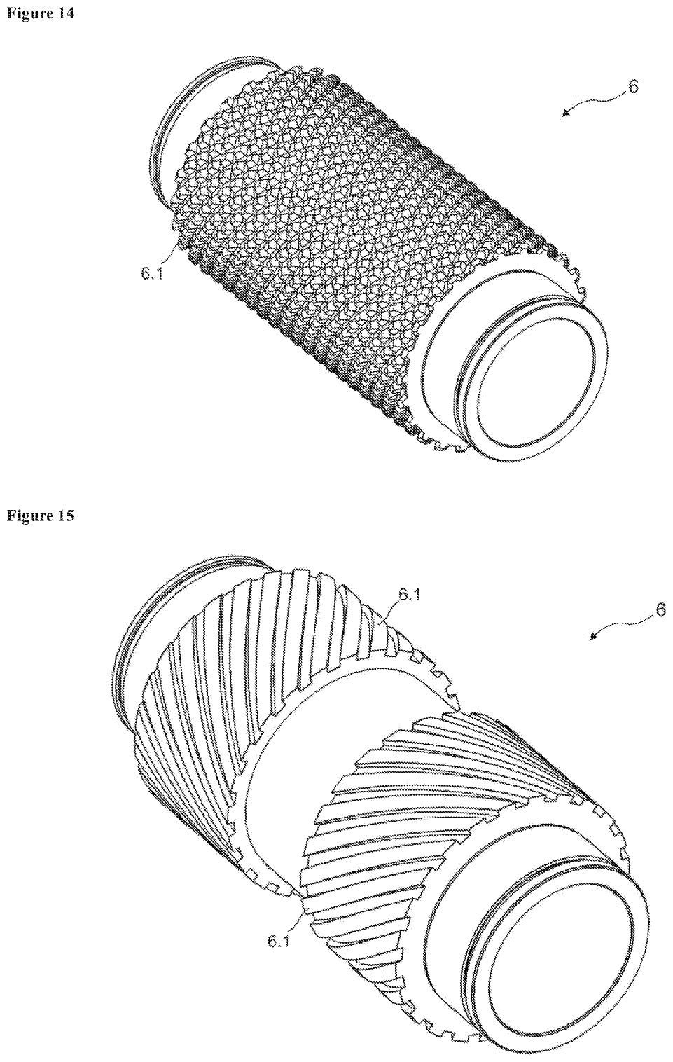

FIG. 14. is a perspective view of the protrusions of the phase shifter, intersecting with each other for movement within the first movement channel and the second movement channel, together with the phase shifter.

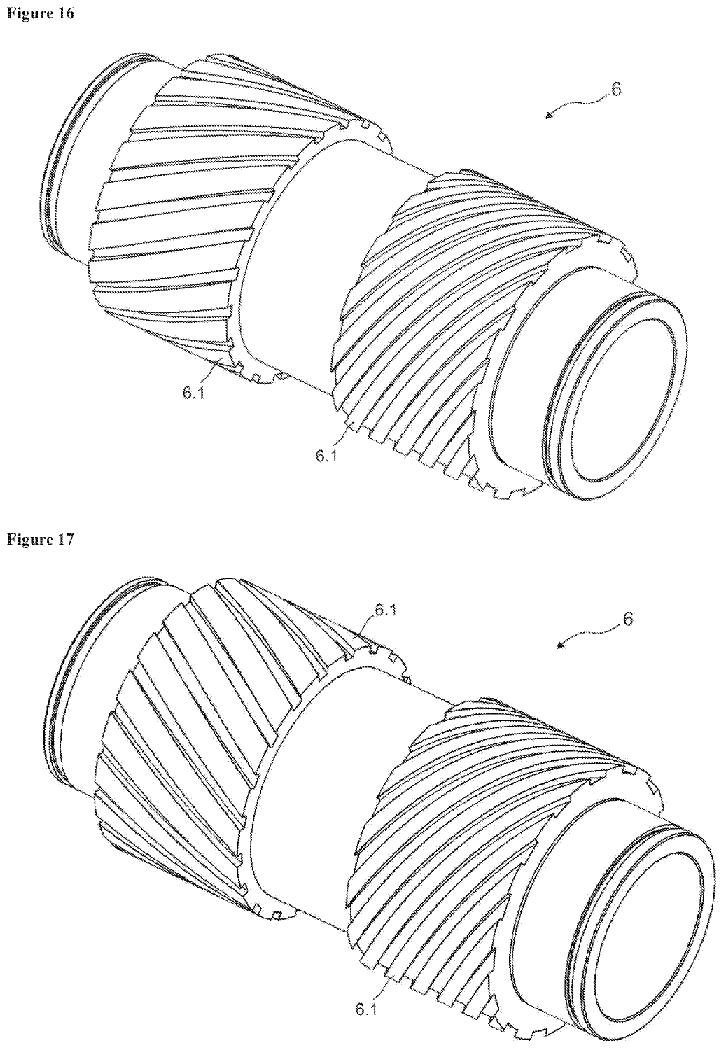

FIG. 15. is a perspective view of the protrusions of the phase shifter, formed at different directions at the same angle for movement within the first movement channel and the second movement channel, together with the phase shifter.

FIG. 16. is a perspective view of the protrusions of the phase shifter, formed at different angles in the same direction for movement within the first movement channel and the second movement channel, together with the phase shifter.

FIG. 17. is a perspective view of the protrusions of the phase shifter, formed at different angles in different directions for movement within the first movement channel and the second movement channel, together with the phase shifter.

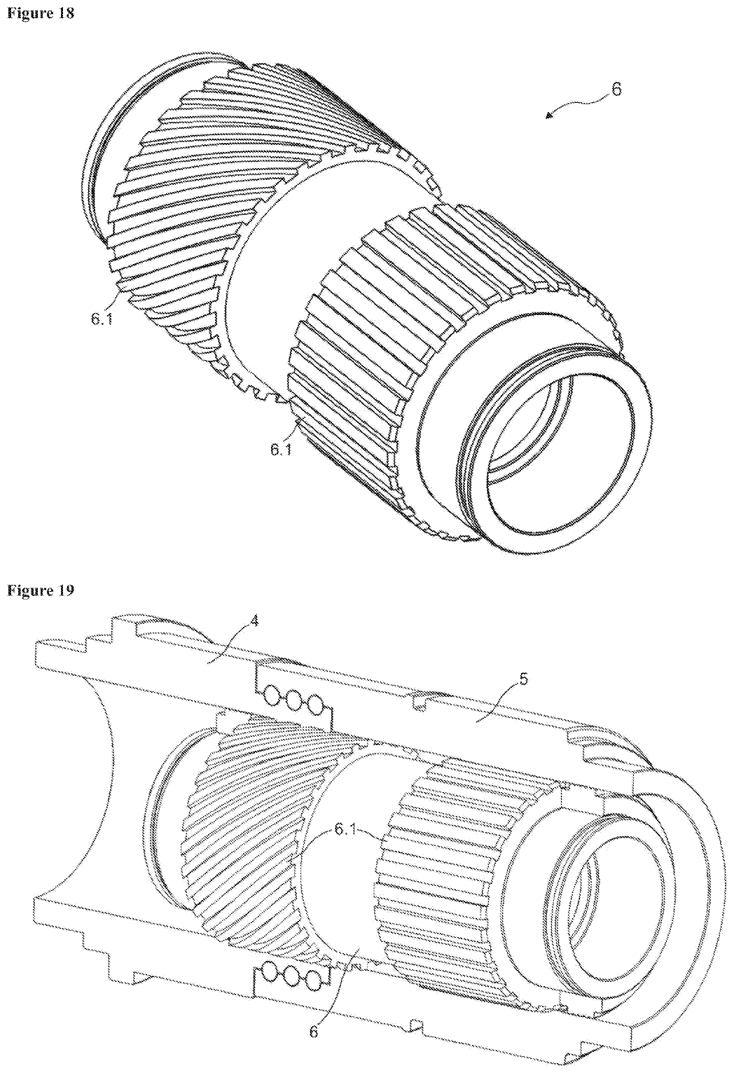

FIG. 18. is a perspective view of the protrusions of the phase shifter, one of which is formed at an angle while the other parallel to the central axis of the phase shifter for movement within the first movement channel and the second movement channel, together with the phase shifter.

FIG. 19. is a perspective view of the phase shifter in FIG. 18 together with the first rotary member and the second rotary member.

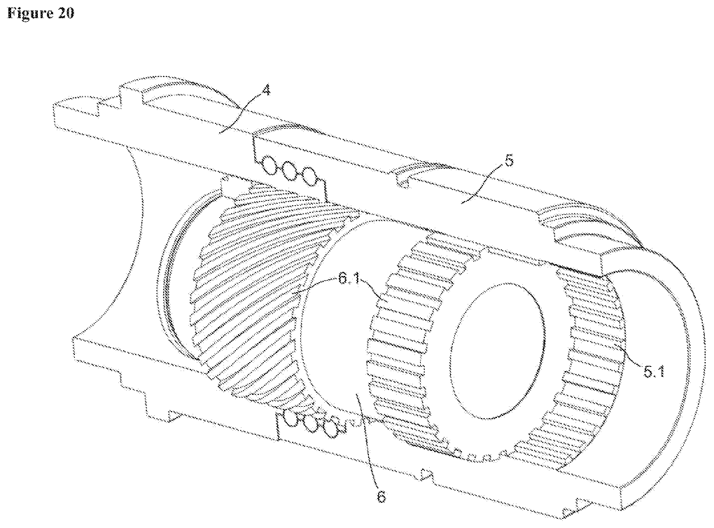

FIG. 20. is a sectional perspective view of the phase shifter in FIG. 18 together with the first rotary member and the second rotary member.

The components shown in the figures are each given reference numerals as follows:
1. Phase shifting mechanism
2. First transmission member
3. Second transmission member
4. First rotary member
   4.1. First movement channel
   4.2. First cavity
      4.2.1. First mounting groove
5. Second rotary member
   5.1. Second movement channel
   5.2. Second cavity
      5.2.1. Second mounting groove
6. Phase shifter
   6.1. Protrusion
   6.2. Circular extension
7. Intermediate member
8. Bearing
   8.1. Ball bearing
   8.2. Adjustment cover
9. Fine adjustment mechanism
   9.1. Adjustment member
   9.2. Lock member
   9.3. Adjustment ball bearing
   9.4. Fixing member
10. Stroke mechanism
   10.1. Body
      10.1.1. Body aperture
      10.1.2. Stroke start surface
   10.2. Pusher
      10.2.1. Pusher head
   10.3. First fluid channel
   10.4. Second fluid channel
   10.5. Stroke adjustment group
      10.5.1. Adjustment nut
         10.5.1.1. Stroke surface
      10.5.2. Fixing nut
U. Vibro hammer
G. First weight set
R. Second weight set

The phase shifting mechanism (1), which is adapted to shift the phase between the first transmission member (2) an the second transmission member (3), essentially comprises
at least one first rotary member (4) which
   is adapted in the form of a hollow shaft rotatable around its own axis together with the first transmission member (2),
   comprises a first movement channel (4.1) in its interior formed in an angled manner relative to its central axis for converting an axial force to a rotational movement;
at least one second rotary member (5) which
   is adapted in the form of a hollow shaft rotatable around its own axis together with the second transmission member (3),
   comprises a second movement channel (5.1) in its interior formed at the same angle with the first movement channel or at a different angle;
at least one phase shifter (6) which
   is disposed inside the first rotary member (4) and the second rotary member (5) such that it is concentric with the central axes of the first rotary member (4) and the second rotary member (5),
   is adapted so as to move back and forth along the said axis,
   comprises at least one protrusion (6.1) able to apply axial force on at least one of the first movement channel (4.1) and the second movement channel (5.1),
   performs phase shifting by rotating at least one of the first rotary member (4) and the second rotary member (5).

Vibro hammers (U) are used particularly in driving and extracting steel formed pipes and profiles to and from the soil upon being mounted on the said parts.

In the vibration generation section provided in the vibro hammers (U), generally there are four weights, two of which are at the lower part (first weight set (G)) and two of which are at the upper part (second weight set (R)). These weights are arranged in two sets of two, one on top of the other (such that there will be one at each corner of a rectangle). In the case that the weights of the first weight set (G) and those of the second weight set are at the same direction, vibrations are formed (unbalanced state) at the vibro hammer (U), whereas if they are at opposite directions, vibrations are not formed (balanced state) at the vibro hammer.

Adjustment of the weights in the first weight group (G) and the second weight group (R) in the same or opposite directions, that is, the transition from the unbalanced state to the balanced state or the transition from the balanced state to the unbalanced state (phase shift), in other words, the vibro hammer (U) generating vibration or not is provided by a phase shifting mechanism (1).

In the phase shifting mechanism (1) provided in this embodiment of the present invention, there is at least one first transmission member (2) and at least one second transmission member (3). The first transmission member (2) and the second transmission member (3) are gears, and the first transmission member (2) is connected to the first weight set (G) while the second transmission member (3) is connected to the second weight set (R). Thus, together with the first transmission member (2) and the first rotary member (4), the first weight set (G) and the second weight set (R) also rotate. Fine adjustment of the first transmission member (2) and the second transmission member (3), thus the first weight set (G) and the second weight set (R) during the rotation process is performed by the fine adjustment mechanism (9).

In the phase shifting mechanism (1) provided in this embodiment of the present invention, the first transmission member (2) is connected to a first rotary member (4). The said first rotary member (4) is preferably formed in the geometric form of a hollow shaft and a first movement channel (4) is provided in its interior. The said first movement channel (4.1) is formed inside the first rotary member (4) in order to convert the axial force applied by the phase shifter (6) to a rotational movement in the first rotary member (4). The first movement channel (4.1) in this embodiment of the invention is formed in a helical geometric form, and the angle of the helical form is determined according to the rotation speed of the first rotary member (4) in the axial movement of the phase shifter (6). The greater the angle (between 1 and 89 degrees) between the angle of the said first movement channel (4.1) and the axis passing through the center of the first rotary member (4), the greater the rotation of the said first rotary member (4) around its own axis will be in case of axial movement of the phase shifter (6). The first movement channel (4.1) in this embodiment of the present invention is formed inside the first rotary member (4) preferably at an angle of forty-five degrees. In another embodiment of the present invention, the said first movement channel (4.1) can be formed at any angle between 1 and 89 degrees to the central axis of the first rotary member (4). When the phase shifter (6) moves within the first rotary member (4) along the central axis of the first rotary member (4), and the protrusion (6.1) or protrusions (6.1) on the phase shifter (6) move along in axial direction within the first movement channel (4.1), the first rotary member (4) is forced to rotate and the first rotary member (4) performs the rotational movement in this way. The first movement channel (4.1) in this embodiment of the invention is preferably comprised of helical shaped extensions and gaps dimensioned from the inner wall of the first rotary member (4) towards the central axis of the first rotary member (4). The first movement channel (4.1) in another embodiment of the invention is comprised of helical cavities formed in sizes that allow the protrusion (6.1) to fit into the inner wall of the first rotary member (4). The first movement channel (4.1) in another embodiment of the invention is produced in a form that is able to rotate the first rotary member (4) around its own axis upon interacting with the protrusion (6.1) when the phase shifter (6) moves back and forth along the central axis of the first rotary member (4). At the part of the first rotary member (4) of this embodiment of the present invention that is close to the second rotary member (5), there is a first cavity (4.2) formed by somewhat reducing the wall thickness of the first rotary member (4) in the direction of the central axis of the first rotary member (4). The said first cavity (4.2) is provided in the first rotary member (4) for the integration of the first rotary member (4) and the second rotary member (5). In this first cavity (4.2) located in the first rotary member (4), there is at least one first mounting groove (4.2.1) provided in a semi-circular geometric form along the wall thickness of the first rotary member (4). In this embodiment of the invention, three first mounting grooves (4.2.1) are provided in the first cavity (4.2).

In the phase shifting mechanism (1) provided in this embodiment of the present invention, a second rotary member (5) is provided in addition the first rotary member (4). Similar to the first rotary member (4), the second rotary member (5) is also formed in the geometric form of a hollow shaft and a second movement channel (5.1) is provided in its interior. The second movement channel (5.1) in this embodiment of the invention is provided inside the second rotary member (5) in order to convert the axial force applied by the phase shifter (6) into a rotational movement in the second rotary member (5). The second movement channel (5.1) in this embodiment of the invention is formed in a helical geometric form, and the angle of the helical form is determined according to the rotation speed of the second rotary member (5) in the axial movement of the phase shifter (6). The greater the angle (between 1 and 89 degrees) between the angle of the said second movement channel (5.1) and the axis passing through the center of the second rotary member (5), the greater the rotation of the said second rotary member (5) around its own axis will be in case of axial movement of the phase shifter (6). The second movement channel (5.1) in this embodiment of the present invention is formed inside the second rotary member (5) preferably at an angle of forty-five degrees. In another embodiment of the present invention, the said second movement channel (5.1) can be formed at any angle between 1 and 89 degrees to the central axis of the second rotary member (5). When the phase shifter (6) moves within the second rotary member (5) along the central axis of the second rotary member (5), and the protrusion (6.1) or protrusions (6.1) on the phase shifter (6) move along in axial direction within the second movement channel (5.1), the second rotary member (5) is forced to rotate and the second rotary member (5) performs the rotational movement in this way. The second movement channel (5.1) in this embodiment of the invention is preferably comprised of helical shaped extensions and gaps dimensioned from the inner wall of the second rotary member (5) towards the central axis of the second rotary member (5). The second movement channel (5.1) in another embodiment of the invention is comprised of helical cavities formed in sizes that allow the protrusion (6.1) to fit into the inner wall of the second rotary member (5). The second movement channel (5.1) in another embodiment of the invention is produced in a form that is able to rotate the second rotary member (5) around its own axis upon interacting with the protrusion (6.1) when the phase shifter (6) moves back and forth along the central axis of the second rotary member (5). The second movement channel (5.1) in another embodiment of the invention is formed so as to be parallel to the central axis of the second rotary member (5) (FIG. 20). When the second movement channel (5.1) is formed so as to be parallel to the central axis of the second rotary member (5), in case of an axial movement of the phase shifter (6), the rotary member (5) does not rotate around its own axis and it only allows the phase shifter (6) to pass therethrough. In this embodiment, the phase shifter (6), while enabling the first rotary member (4) to rotate around its own axis, moves within the second rotary member (5) but does not rotate the second rotary member (5).

The protrusions (6.1) on the phase shifter (6) of another embodiment of the invention are formed so as to be able to apply axial force in the first movement channel (4.1) and the second movement channel (5.1) and to be compatible with the geometric forms of the said channels (4.1, 5.1) and as an intersection of the said forms (FIG. 14). Thus, while the phase shifter (6) is moving axially within the first movement channel (4.1) and the second movement channel (5.1), the protrusions (6.1) can move along within the first movement channel (4.1) and the second movement channel (5.1).

The protrusions (6.1) on the phase shifter (6) of another embodiment of the invention are formed at the same angle in different directions so as to be able to apply axial force in the first movement channel (4.1) and the second movement channel (5.1) (FIG. 15). In this case, the first movement channel (4.1) and the second movement channel (5.1) are formed similar to the said protrusions (6.1). In case of axial movement of the phase shifter (6), the first rotary member (4) and the second rotary member (5) can rotate at the same speed in different directions.

The protrusions (6.1) on the phase shifter (6) of another embodiment of the invention are formed at different angles in the same direction so as to be able to apply axial force in the first movement channel (4.1) and the second movement channel (5.1) (FIG. 16). In this case, the first movement channel (4.1) and the second movement channel (5.1) are formed similar to the said protrusions (6.1). In case of axial movement of the phase shifter (6), the first rotary member (4) and the second rotary member (5) can rotate at different speeds in the same direction.

The protrusions (6.1) on the phase shifter (6) of another embodiment of the invention are formed at different angles in different directions so as to be able to apply axial force in the first movement channel (4.1) and the second movement channel (5.1) (FIG. 17). In this case, the first movement channel (4.1) and the second movement channel (5.1) are formed similar to the said protrusions (6.1). In case of axial movement of the phase shifter (6), the first rotary member (4) and the second rotary member (5) can rotate at different speeds in different directions.

The protrusions (6.1) on the phase shifter (6) of another embodiment of the invention are formed such that a part of them are at one direction and another part thereof is parallel to the central axis of the phase shifter (6), so as to apply axial force to the first movement channel (4.1) while not applying any axial force to the second movement channel (5.1) (FIG. 18). In this case, the first movement channel (4.1) and the second movement channel (5.1) are formed similar to the said protrusions (6.1). In case of axial movement of the phase shifter (6), while the first rotary member (4) rotates in one direction, the second rotary member (5) does not perform any rotational movement.

At the part of the second rotary member (5) of this embodiment of the present invention that is close to the first rotary member (4), there is a second cavity (5.2) formed by somewhat reducing the wall thickness of the second rotary member (5) in the direction of the central axis of the second rotary member (5). The said second cavity (5.2) is provided in the second rotary member (5) for the integration of the first rotary member (4) and the second rotary member (5). In this second cavity (5.2) located in the second rotary member (5), there is at least one second mounting groove (5.2.1) provided in a semi-circular geometric form along the wall thickness of the second rotary member (5). In this embodiment of the invention, three second mounting grooves (5.2.1) are provided in the second cavity (5.2) just as it is in the first cavity (4.2).

When the said first rotary member (4) and the second rotary member (5) of this embodiment of the invention are engaged to each other concentrically, the first cavity (4.2) and the second cavity (5.2) are placed on top of each other and the first mounting groove (4.2.1) and the second mounting groove (5.2.1) form a circular clearance into which the intermediate member (7) can fit. A plurality of intermediate members (7) is placed inside the circular clearance formed by the first mounting groove (4.2.1) and the second mounting groove (5.2.1), and by this means, the first rotary member (4) and the second rotary member (5) are rotated around relatively the same axis relative to each other while separation thereof from each other in the axial direction is prevented. The intermediate member (7) used in this embodiment of the invention is a ball, and a plurality thereof is placed within the circular clearance formed by the first mounting groove (4.2.1) and the second mounting groove (5.2.1). In this embodiment of the invention, there are three first mounting grooves (4.2.1) and three second mounting grooves (5.2.1), each of which is filled with intermediate members (7).

In the phase shifting mechanism (5) of this embodiment of the present invention, a bearing (8) is provided at the sides of the first rotary member (4) and the second rotary member (5) that are not close to each other. The said bearing (8) is supported by ball bearings (8.1), and while the bearing (8) remains fixed thanks to the said bearings (8.1), the first rotary member (4) and the second rotary member (5) can rotate around their own axes. In order to enable intervention to the middle parts of said first rotary member (4) and the second rotary member (5) provided in this embodiment of the invention, at least one adjustment cover (8.2) is positioned on the sides of the first rotary member (4) and the second rotary member (5) that are not close to each other. By removing the said adjustment cover (8.2), the inside of the first rotary member (4) and the second rotary member (5) can be intervened.

The phase shifting mechanism (1) of this embodiment of the invention includes at least one phase shifter (6) which is positioned concentrically with the central axis of the first rotary member (4) and the second rotary member (5) and is adapted to move back and forth along the said axis. The said phase shifter (6) is also in the form of a hollow shaft similar to the first rotary member (4) and the second rotary member (5). A circular extension (6.2) is formed inside the phase shifter (6) of this embodiment of the invention in order to keep the fine adjustment mechanism (9) at the location where it is positioned. The said circular extension (6.2) is formed along the whole circumference of the inner part of the phase shifter (6) from the inner part of the phase shifter (6) towards the central axis of the phase shifter (6). This way, the fine adjustment mechanism (9) can be fixed inside the phase shifter (6) and it can be intervened through the adjustment cover (8.2).

At the outer part of the phase shifter (6) of this embodiment of the invention, there are provided one or more protrusions (6.1) which interact with the first movement channel (4.1) and the second movement channel (5.1), and which, while the phase shifter (6) is performing axial movement, enable the first rotary member (4) and the second rotary member (5) to perform rotational movement. The protrusion (6.1) provided in this embodiment of the invention is formed in cylindrical form and in sizes that can fit into the first movement channel (4.1) and the second movement channel (5.1) and such that it will extend outward from the outer surface of the phase shifter (6). At the outer circumference of the phase shifter (6) of this embodiment of the invention, a plurality of protrusions (6.1) is formed in such a way that they are spaced apart, and that they are placed in the first movement channel (4.1) and the second movement channel (5.1) to apply a vector force to the said channels (4.1, 5.1). The position of the said protrusions (6.1) on the outer surface of the phase shifter (6) is adjusted according to the angles at which the first movement channel (4.1) and the second movement channel (5.1) are formed. Thus, in case the phase shifter (6) is moved axially, the protrusions (6.1) move along within the first movement channel (4.1) and the second movement channel (5.1), where they apply a vector force forcing the first rotary member (4) and the second rotary member (5) to rotate. In another embodiment of the invention, the protrusions (6.1) are adapted such that they can fit into the first movement channel (4.1) and the second movement channel (5.1) and move along within the said channels (4.1, 5.1) forcing the first rotary member (4) and the second rotary member (5) to rotate. In another embodiment of the invention, the protrusions (6.1) are adapted such that they can fit into the first movement channel (4.1) and the second movement channel (5.1), but cannot rotate the second rotary member (5), although they can rotate the first rotary member (4).

In the phase shifting mechanism (1) of this embodiment of the invention, a fine adjustment mechanism (9) is adapted for fine adjustment of arrangement of the weights of the first weight set (G) and the second weight set (R), which are connected to the first transmission member (2) and the second transmission member (3), in the same or opposite directions. The fine adjustment mechanism (9) of this embodiment of the invention is positioned inside the phase shifter (6) where the circular extension (6.2) is located. In the fine adjustment mechanism (9) of this embodiment of the invention, there are two adjustment ball bearings (9.3), and said adjustment ball bearings (9.3) are positioned on both sides of the circular extension (6.2). A fixing member (9.4) is located on one side of the adjustment ball bearings (9.3) and on the other side thereof there is an adjustment member (9.1) passing through both the adjustment ball bearings (9.3) and the fixing member (9.4). In case the said adjustment member (9.1) is rotated around its own axis in one direction, the phase shifter (6) moves in a precise manner in one direction along its own central axis, and in case the adjustment member (9.1) is rotated around its own axis in another direction, the phase shifter (6) moves in a precise manner in the opposite direction along its own central axis. The said precise movement of the phase shifter (6) results in precise rotation of the first rotary member (4) and the second rotary member (5) around their own axes, and in this case, arrangement of the weights of the first weight set (G) and the second weight set (R) in the same direction or opposite directions can be adjusted in a precise manner. After performing the adjustment in a precise manner, the adjustment member (9.1) is locked by means of the lock member (9.2), and rotation of the adjustment member (9.1) around its own axis and thus disturbance of the fine adjustment are prevented.

The phase shifting mechanism (1) of this embodiment of the invention includes at least one stroke mechanism (10) adapted to move the phase shifter (6) back and forth along the central axis of the first rotary member (4) and the second rotary member (5). In the said stroke mechanism (10) there is at least one body (10.1) with a body aperture (10.1.1) inside it. The said body (10.1) is in a cylindrical geometric form with a body aperture (10.1.1) inside it and it is closed on both sides. The body (10.1) has a structure that can be removed for maintenance and replaced independently from the first rotary member (4) and the second rotary member (5). The central axes of the first rotary member (4), the second rotary member (5) and the phase shifter (6) and the central axis of the body (10.1) are concentric with respect to each other. Inside the body (10.1), there is a pusher (10.2) which can move back and forth along the central axis of the body (10.1) and which is indirectly connected to the phase shifter (6) through the fine adjustment mechanism (9). The pusher (10.2) in this embodiment of the invention is a piston. The said pusher (10.2) can move back and forth along the central axis of the body (10.1) by means of the drive it receives, and in this case, it enables the phase shifter (6) to move back and forth. A pusher head (10.2.1) is located on one side of the pusher (10.2), and the outer diameter of the said pusher head (10.2.1) and the inner diameter of the body (10.1) are almost the same size with respect to each other. Thus, the pusher head (10.2.1) creates a sealing when moving within the body aperture (10.1.1). The pusher (10.2) is connected to the adjustment member (9.1) and the lock member (9.2) provided in the fine adjustment mechanism (9) from the other end thereof without the pusher head (10.2.1). By this means, the phase shifter (6), fine adjustment mechanism (9) and the pusher (10.2) move in the axial direction at the same speed and in the same direction. The pusher (10.2) in the stroke mechanism (10) of this embodiment of the invention can move back and forth along the central axis of the body (10.1) by means of a fluid directed into the first fluid channel (10.3) and the second fluid channel (10.4). In this embodiment of the invention, the first fluid channel (10.3) and the second fluid channel (10.4) are provided in the body (10.1) in such a way so as to be able to move the pusher (10.2). In cases where it is preferred to move the pusher (10.2) and thus the phase shifter (6) in one direction, a fluid is directed through the first fluid channel (10.3) into the body aperture (10.1.1) thereby enabling the part between one side of the pusher head (10.2.1) and the body aperture (10.1.1) to be filled with fluid and the said fluid to apply pressure to the pusher head (10.2.1). In this case, the pusher head (10.2.1) and thus the pusher (10.2) are subjected to pressure and move axially in one direction. In the case where it is preferred to move the pusher (10.2) axially in another direction, a fluid is directed through the second fluid channel (10.4) into the body aperture (10.1.1), and in this case, the part between the other side of the pusher head (10.2.1) and the body aperture (10.1.1) is filled with fluid and the said fluid applies pressure to the pusher head (10.2.1). In this case, the pusher head (10.2.1) and thus the pusher (10.2) are subjected to pressure and move axially in another direction. Since the body (10.1) is arranged independently from the first rotary member (4), the second rotary member (5) and the phase shifter (6); the fluid leaks and failures that may occur within the body (10.1) due to use can be resolved by only intervening with the body (10.1), and no intervention is required with the first rotary member (4), the second rotary member (5) and the phase shifter (6).

The movement of the pusher (10.2) of this embodiment of the invention from one point to another point by means of a fluid directed from the first fluid channel (10.3) or the second fluid channel (10.4) within the body aperture (10.1.1) is defined as stroke. In order to determine a reference start of this stroke, there is a stroke starting surface (10.1.2) on one of the closed sides of the body aperture (10.1.1) inside the body (10.1). The said stroke starting surface (10.1.2) is defined as the reference surface for adjusting the stroke that the pusher (10.2) and therefore the pusher head (10.2.1) will travel. The stroke at which the pusher (10.2) will travel from the stroke starting surface (10.1.2) is adjusted by means of the stroke adjustment group (10.5). The stroke adjustment group (10.5) is positioned on the opposite side of the stroke starting surface (10.1.2) in the body aperture (10.1.1) in order to be able to adjust the amount of the stroke (distance) the pusher (10.2) will travel from the stroke starting surface (10.1.2). There is at least one adjustment nut (10.5.1) in the stroke adjustment group (10.5). The said adjustment nut (10.5.1) is connected to the body (10.1) and is located opposite to the stroke starting surface (10.1.2) in the body aperture (10.1.1). There is a stroke surface (10.5.1.1) on the said adjustment nut (10.5.1). The stroke surface (10.5.1.1) is located opposite to the stroke starting surface (10.1.2). When the adjustment nut (10.5.1) is connected to the body (10.1) and rotated in a direction around its own axis taking the body (10.1) as reference, it can move axially towards the stroke starting surface (10.1.2), and when rotated in the opposite direction, it can move axially in a direction away from the stroke starting surface (10.1.2). In this way, the distance between the stroke starting surface (10.1.2) and the stroke surface (10.5.1.1) can be adjusted. The said distance is also the stroke that the pusher (10.2) can travel. In other words, the amount of stroke that the pusher (10.2) is intended to travel is adjusted by rotating the said stroke adjustment nut (10.5.1) around its own axis thereby moving the stroke surface (10.5.1.1) towards or away from the stroke starting surface (10.1.2). After the adjustment of the stroke by means of the adjustment nut (10.5.1), the fixing nut (10.5.2) and the adjustment nut (10.5.1) are fixed and in this case any movement of the adjustment nut (10.5.1) and changing of the stroke are prevented.

The operation of the phase shifting mechanism (1) of this embodiment of the invention is carried out as follows. In this embodiment of the present invention, the first rotary member (4) and the second rotary member (5) are positioned to be concentric and such that the phase shifter (6) can be placed therein. In this embodiment of the invention, the first movement channel (4.1) and the second movement channel (5.1) are preferably formed at forty-five degrees. In this case, when the phase shifter (6) moves axially, the first rotary member (4) can rotate in one direction and the second rotary member (5) in the opposite direction to the direction in which the first rotary member (4) rotates at the same speed. In the first stage, the first transmission member (2) is adjusted to face the weights in the first weight set (G) and the second transmission member (3) is adjusted to face the weights in the second weight set (R) in the same direction or opposite directions as possible. Afterwards, by rotating the adjustment member (9.1) provided in the fine adjustment mechanism (9) around its own axis, the phase shifter (6) is somewhat moved in axial direction and thus the first weight set (G) and the second weight set (R) are adjusted to be exactly at the same or opposite directions relative to each other. After the said adjustment is completed, the adjustment member (9.1) is locked by means of the lock member (9.2) and in this way, it is ensured that the first weight set (G) and the second weight set (R) are exactly at the same direction or opposite directions relative to each other. At the stage of making and completing this adjustment, the pusher head (10.2.1) is in surface-to-surface contact with the stroke starting surface (10.1.2). After the completion of the adjustment by means of the fine adjustment mechanism (9), the amount of rotation of the first rotary member (4) and the second rotary member (5) carried out by the axial movement of the phase shifter (6) that will cause the first weight set (G) and the second weight set (R) to switch from the opposite directions to the same direction (from balanced state to unbalanced state) or from the same direction to the opposite directions (from unbalanced state to balanced state) is calculated and the stroke is determined accordingly. Following calculation of the stroke, the distance (stroke) between the stroke surface (10.5.1.1) and the stroke starting surface (10.1.2) is adjusted by rotating the adjustment nut (10.5.1) provided in the stroke adjustment group (10.5) around its own axis, and this way the phase shifting mechanism (1) is made operable. In the following process, the vibro hammer (U) is rotated at a preferred speed (rpm). In the process of startup, the weights in the first weight set (G) and the second weight set (R) are in opposite directions (balanced state). When the vibro hammer (U) is working at this configuration, if the weights in the first weight set (G) and the second weight set (R) are preferred to be turned towards the same direction (unbalanced state), a fluid is directed through the second fluid channel (10.4) and the pusher head (10.2.1) and therefore the pusher (10.2) are enabled to move from the stroke starting surface (10.1.2) towards the stroke surface (10.5.1). In this case, the pusher (10.2) and therefore the phase shifter (6) also move axially. In case of the said movement, the phase shifter (6) ensures that both the first rotary member (4) and the second rotary member (5) rotate in different directions relative to each other. This rotation naturally enables the first weight set (G) and the second weight set (R) to rotate relative to each other and move from balanced state to unbalanced state. When the pusher head (10.2.1) contacts the stroke surface (10.5.1.1), the whole movement is completed, and the first weight set (G) and the second weight set (R) completely pass from the balanced state to the unbalanced state. When the vibro hammer (U) is in the unbalanced state, if it is preferred to switch to balanced state after it drives or removes a preferred element, this time a fluid is directed through the first fluid channel (10.3) and in this case the pusher head (10.2.1) moves from the stroke surface (10.5.1.1) up to the stroke starting surface (10.1.2). In this case, the phase shifter (6) performs the exact opposite of its first movement and rotates the first rotary member (4) and the second rotary member (5) in the exact opposite direction thereby ensuring that the first weight set (G) and the second weight set (R) are switched from the unbalanced state to the balanced state.

1. A phase shifting mechanism, which is adapted to shift the phase between a first transmission member and a second transmission member, comprising
at least one first rotary member which:
is adapted in the form of a hollow shaft rotatable around its own axis together with the first transmission member,
comprises a first movement channel in its interior formed in an angled manner relative to its central axis for converting an axial force to a rotational movement;
at least one second rotary member which:
is adapted in the form of a hollow shaft rotatable around its own axis together with the second transmission member,
comprises a second movement channel in its interior formed at the same angle with the first movement channel or at a different angle;
at least one phase shifter which:
is disposed inside the first rotary member and the second rotary member such that it is concentric with the central axes of the first rotary member and the second rotary member,
is adapted so as to move back and forth along the said axis,
comprises at least one protrusion able to apply axial force on at least one of the first movement channel and the second movement channel,
performs phase shifting by rotating at least one of the first rotary member and the second rotary member.

2. Phase shifting mechanism according to claim 1, wherein the first movement channel:
is formed inside the first rotary member in order to convert the axial force applied by the phase shifter to a rotational movement in the first rotary member,
which, in case of the axial movement of the phase shifter, increases the speed of rotation of the first rotary member around its own axis depending on the increase of the difference of angle between itself and the axis passing through the center of the first rotary member.

3. Phase shifting mechanism according to claim 1, wherein the first movement channel:
is formed in a helical geometric form, and the angle of the helical form of which is determined according to the rotation speed of the first rotary member in the axial movement of the phase shifter,
is comprised of at least one of helical shaped extensions, gaps and cavities dimensioned from the inner wall of the first rotary member towards the central axis of the first rotary member,
is produced in a form that is able to rotate the first rotary member around its own axis upon interacting with the protrusion when the phase shifter moves back and forth along the central axis of the first rotary member.

4. (canceled)

5. (canceled)

6. Phase shifting mechanism according to claim 1, wherein the first rotary member:
when the phase shifter moves, is forced to rotate depending on the movement of the protrusion or protrusions on the phase shifter in axial direction within the first movement channel and
comprises a first cavity which is formed for integration with the second rotary member at the part thereof that is close to the second rotary member by somewhat reducing the wall thickness thereof in the direction of its central axis.

7. (canceled)

8. (canceled)

9. (canceled)

10. Phase shifting mechanism according to claim 1, wherein the second movement channel:
is formed in a helical geometric form, and the angle of the helical form of which is determined according to the rotation speed of the second rotary member in the axial movement of the phase shifter,
which, in case of the axial movement of the phase shifter, increases the speed of rotation of the second rotary member around its own axis depending on the increase of the difference of angle between itself and the axis passing through the center of the second rotary member, and
which is comprised of at least one of helical shaped extensions, gaps and cavities dimensioned from the inner wall of the second rotary member towards the central axis of the second rotary member.

11. (canceled)

12. Phase shifting mechanism according to claim 1, wherein the second rotary member which, when the phase shifter moves, is forced to rotate depending on the movement of the protrusion or protrusions on the phase shifter in axial direction within the second movement channel.

13. (canceled)

14. (canceled)

15. (canceled)

16. Phase shifting mechanism according to claim 1, wherein the first rotary member and the second rotary member, when engaged to each other concentrically, the first cavities and the second cavities are placed on top of each other, and the first mounting groove and the second mounting groove form a circular clearance into which an intermediate member can fit.

17. (canceled)

18. (canceled)

19. (canceled)

20. (canceled)

21. (canceled)

22. Phase shifting mechanism according to claim 1, wherein one or more protrusions:
are adapted to interact with the first movement channel and the second movement channel at the outer part of the phase shifter and to enable the first rotary member and the second rotary member to perform rotational movement when the phase shifter is performing axial movement; and
are formed in cylindrical form and in sizes that can fit into the first movement channel and the second movement channel and such that it will extend outward from the outer surface of the phase shifter.

23. (canceled)

24. (canceled)

25. (canceled)

26. (canceled)

27. Phase shifting mechanism according to claim 1, wherein a fine adjustment mechanism is positioned inside the phase shifter for fine adjustment of arrangement of the weights of the first weight set and the second weight set, which are connected to the first transmission member and the second transmission member, in the same or opposite directions, and having at least one adjustment ball bearing and an adjustment member passing through the adjustment ball bearings and which, when rotated around its own axis in one direction, moves the phase shifter in a precise manner in one direction along its own central axis, and when rotated around its own axis in another direction, moves the phase shifter in a precise manner in the opposite direction along its own central axis.

28. (canceled)

29. (canceled)

30. Phase shifting mechanism according to claim 1, comprising at least one stroke mechanism:
having a stroke adjustment group which enables to adjust the stroke,
is adapted to move the phase shifter back and forth along the central axis of the first rotary member and the second rotary member and
has a pusher, which, depending on the drive provided thereto, moves back and forth along the central axis and thereby enabling the phase shifter to move back and forth.

31. (canceled)

32. (canceled)

33. (canceled)

34. (canceled)

35. Phase shifting mechanism according to claim 1, wherein a stroke mechanism, having a first fluid channel, through which a fluid is directed into the body aperture in cases where it is preferred to move the pusher and thus the phase shifter in one direction, thereby enabling the part between one side of the pusher head and the body aperture to be filled with fluid and the said fluid to apply pressure to the pusher head, and a second fluid channel, through which a fluid is directed into the body
aperture in cases where it is preferred to move the pusher in another direction, thereby enabling the part between the other side of the pusher head and the body aperture to be filled with fluid and the said fluid to apply pressure to the pusher head, wherein the back and forth movement of the pusher) along the central axis of the body is enabled by the fluid directed into them.

36. (canceled)

37. (canceled)

38. (canceled)

39. Phase shifting mechanism according to claim 30, wherein the stroke adjustment group:
enables to adjust the stroke at which the pusher will travel from the stroke starting surface,
is positioned on the opposite side of the stroke starting surface in the body aperture in order to be able to adjust the amount of the stroke (distance) the pusher will travel from the stroke starting surface and
having an adjustment nut which is connected to the body and located opposite to the stroke starting surface in the body aperture, and which includes thereon a stroke surface.

40. (canceled)

41. (canceled)

42. Phase shifting mechanism according to claim 39, the stroke adjustment group having an adjustment nut, which, when rotated in a direction around its own axis taking the body as reference, can move axially towards the stroke starting surface, and when rotated in the opposite direction, can move axially in a direction away from the stroke starting surface, and having a fixing nut, which, after the adjustment of the stroke by means of the adjustment nut, enables the adjustment nut to be fixed.

43. (canceled)

44. Phase shifting mechanism according to claim 1, the phase shifter having protrusions which are formed so as to be able to apply axial force in the first movement channel and the second movement channel and to be compatible with the geometric forms of the said channels and as an intersection of the said forms.

45. Phase shifting mechanism according to claim 1, the phase shifter:
having protrusions which are formed at the same angle in different directions so as to be able to apply axial force in the first movement channel and the second movement channel, or
having protrusions which are formed at different angles in the same direction so as to be able to apply axial force in the first movement channel and the second movement channel or
having protrusions which are formed at different angles in different directions so as to be able to apply axial force in the first movement channel and the second movement channel or
having protrusions which are formed such that a part of them are at one direction and another part thereof is parallel to the central axis of the phase shifter, so as to apply axial force to the first movement channel while not applying any axial force to the second movement channel.

46. (canceled)

47. (canceled)

48. (canceled)
